(19) United States
(12) Patent Application Publication
(10) Pub. No.: US 2014/0192033 A1
(43) Pub. Date: Jul. 10, 2014

(54) 3D IMAGE APPARATUS AND METHOD FOR DISPLAYING IMAGES

(71) Applicant: HTC CORPORATION, Taoyuan County (TW)

(72) Inventors: Ching-Ming Hsu, Taoyuan County (TW); Yi-Yuan Hsieh, Taoyuan County (TW); Po-Chang Ho, Taoyuan County (TW)

(73) Assignee: HTC CORPORATION, Taoyuan County (TW)

(21) Appl. No.: 13/735,043

(22) Filed: Jan. 7, 2013

(51) Int. Cl. G09G 5/14

(52) U.S. Cl. CPC G09G 5/14
USPC 345/207

(57) ABSTRACT

A three-dimensional (3D) image apparatus is provided. The 3D image apparatus includes a display unit, a front camera, and a processor. The front camera captures an image of the eyes of the user. The processor is coupled to the display unit and the front camera. The processor determines the position of the eyes of the user based on the image of the eyes of the user, and determines whether to display a 3D image or a two-dimensional (2D) image on the display based on the position of the eyes of the user.

### BACKGROUND OF THE INVENTION

1. Field of the Invention

The present invention relates to a three-dimensional (3D) image apparatus. More particularly, the present invention relates to a method for displaying images applicable to the 3D image apparatus.

2. Description of the Related Art

Nowadays 3D displays and 3D cameras are getting prevalent. A 3D camera includes two cameras simulating the two eyes of human for taking 3D images. A 3D camera usually includes a built-in 3D display for the user to preview the 3D images he or she is taking. When a 3D camera is focusing, the images displayed by the built-in 3D display often lose focus and the user may feel a little dizzy.

There are many techniques for generating 3D effects on a planar display. Barrier layer is one of the techniques. The barrier is a structure designed for masking pixels of a 3D display such that the right eye of the user sees only the sub-image intended for the right eye and the left eye of the user sees only the sub-image intended for the left eye. Because of the physical limitation of the barrier, eyes of the user must be at the right position to view 3D images. Otherwise, the 3D images may lose focus and the user may feel a little dizzy.

### SUMMARY OF THE INVENTION

Accordingly, the present invention is directed to a 3D image apparatus and a method for displaying images for solving the aforementioned dizziness problem.

According to an embodiment of the present invention, a 3D image apparatus is provided. The 3D image apparatus includes a display unit, a front camera, and a processor. The front camera captures an image of the eyes of the user. The processor is coupled to the display unit and the front camera. The processor determines the position of the eyes of the user based on the image of the eyes of the user, and determines whether to display a 3D image or a two-dimensional (2D) image on the display based on the position of the eyes of the user.

According to another embodiment of the present invention, a method for displaying images is provided, which includes the following steps: capturing an image of the user, determining viewing position of the user based on the image of the user, and determining whether to display a 3D image or a 2D image on a display unit based on the viewing position of the user.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a 3D image apparatus according to another embodiment of the present invention.

FIG. 2 is a flow chart showing a method for displaying images according to an embodiment of the present invention.

FIG. 3 is a schematic diagram showing a display and the eyes of the user according to an embodiment of the present invention.

FIG. 4 is a schematic diagram showing a display and the eyes of the user according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

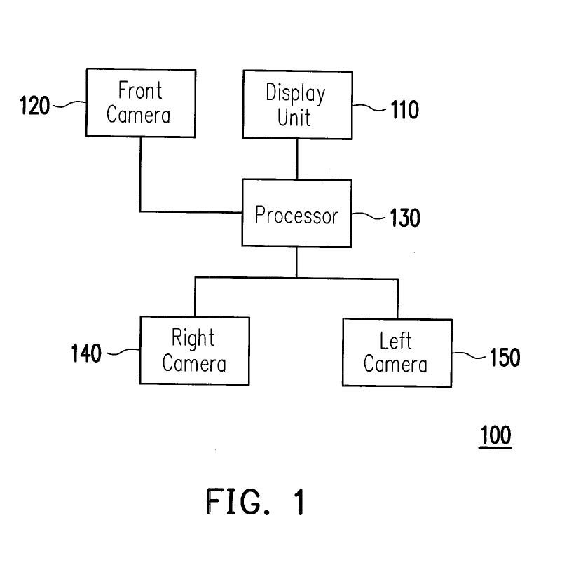

FIG. 1 is a schematic diagram showing a 3D image apparatus 100 according to another embodiment of the present invention. The 3D image apparatus 100 may be a 3D camera, 3D monitor, 3D game console, 3D television or any other electronic device that supports 3D display. The 3D image apparatus comprises at least a display unit 110, a front camera 120, a processor 130, a right camera 140 and a left camera 150. The front camera 120, the right camera 140 and the left camera 150 may form a camera set in one embodiment of the invention. The front camera 120 is located at the same side of the display unit 110, which can be used to capture images of the user when user is viewing display contents on the display unit 110. The right camera 140 and the left camera 150 are located at the opposite side of the 3D image apparatus with respect to the display unit 110, which can be used to capture same view of scene as the user's eyes. The images captured by the front camera 120, the right camera 140 and the left camera 150 are sent to the processor 130 for processing and the processor 130 is configured to provide processed images for displaying on the display unit 110. In one embodiment of the invention, the processor 130 may be an image signal processor, application processor, and/or other processors capable to perform image processing. To provide 3D view of images, the processor 130 may receive images captured by the right camera 140 and the left camera 150, or access images from other storage device such as internal memory, external memory and/or other storage device connected to the 3D image apparatus 100. The display unit 110 may provide 3D view of images by providing a right image and a left image simultaneously in a way that right eye of the user may only see the right image and the left eye of the user may only see the left image at the same time. The display unit 110 further comprises at least a barrier module and a pixel module (not shown). The barrier module is configured to control the 3D display on/off of the display unit. In 2D display mode, the barrier module may be turn off therefore both eyes of the user would see the same image at the same time. In 3D display mode, the barrier module is turn on to provide viewing angles of the right images limited to the right eye and the viewing angle of the left images limited to the left eye. The barrier module may comprise at least one layer of barrier. However the invention is not limited to any number of layers.

When 3D display mode is enabled, the display unit turns on the barrier module and provides corresponding right images and left images at the same time. To create 3D viewing effect, the right images seen by the user's right eye and the left images seen by the user's left eye should have some displacement so as to create depth of view. However, the displacement of the right eye view and the left eye view should be controlled in proper distance otherwise the scene would look dispersed and thus uncomfortable. As a result, if the user is viewing at a wrong distance or a wrong angle, the 3D images would look fuzzy and thus uncomfortable. The present invention utilizes the front camera 120 of the 3D image apparatus 100 to capture an image of the user's face, extract eye position information from the face image and determine whether the user is viewing at proper position for 3D display mode. In response to the user is viewing at a position (distance, angle, etc.) outside a predetermined range having clear 3D focus, the 3D image apparatus 100 may temporarily switch to 2D display mode until it is determined that the images are in 3D focus with respect to user's eyes. In this way, user would have better viewing experience.

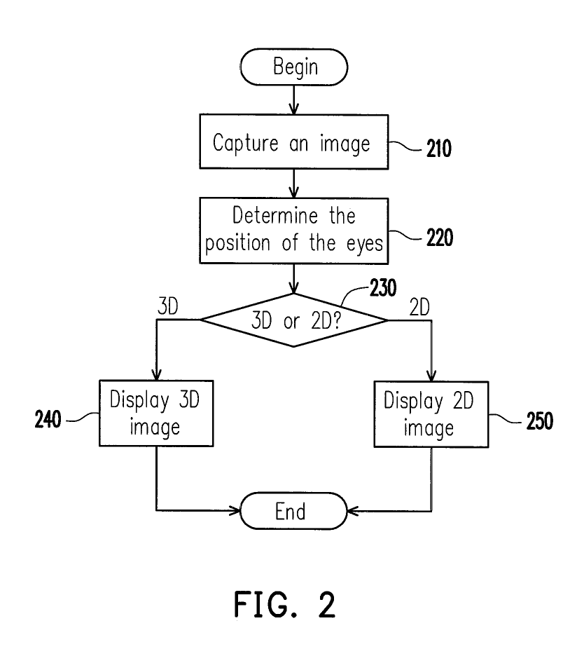

FIG. 2 is a flow chart showing a method for displaying images according to an embodiment of the present invention. At step 210, the front camera 120 captures an image of the user, the image may comprise eye information of the user. At step 220, the processor determines the position of the eyes of the user based on the image captured by the front camera 120. The processor may perform face/eye detection to identify user's eye in the image, and determine the position of the eyes with respect to the 3D image apparatus. For example, the processor may perform face detection known in the art first and locate eye area from other region of the face by color contrast. Then the positions of the two eyes are calculated according to the location of the center. The position of the eyes of the user may comprise two relative positions, namely, the relative position between the eyes of the user and the display unit 110, and the relative position between the eyes and the face of the user. The relative position of the eyes of the user to the display unit 110 and the face of the user may be derived from the distance of the eye positions and focal length of the 3D image apparatus 100, for example. Other method can also be used to find the geometry relationship of the eye distance and the display unit 110 and the face of the user. At step 230, the processor 130 determines whether to display a 3D image or a two-dimensional (2D) image on the display unit 110 based on the eye position in the captured image. Next, the processor 130 displays the 3D image on the display unit 110 at step 240 or displays the 2D image on the display unit 110 at step 250 based on the determining step 230. In one embodiment of the invention, if eye position in the captured image suggests that the user is viewing in an angle not within 3D visible range, the processor 130 instructs the display unit 110 to switch to 2D display mode and provides 2D images to the display unit 110. In another embodiment of the invention, the processor 130 may instruct to switch to 2D display mode in response to the eye position in the captured image suggests that the user is viewing at a distance away from the 3D visible range. There are many criteria for the processor 130 to determine whether to display the 3D image or temporarily the 2D image when 3D display mode is enabled. The details of the criteria are discussed below.

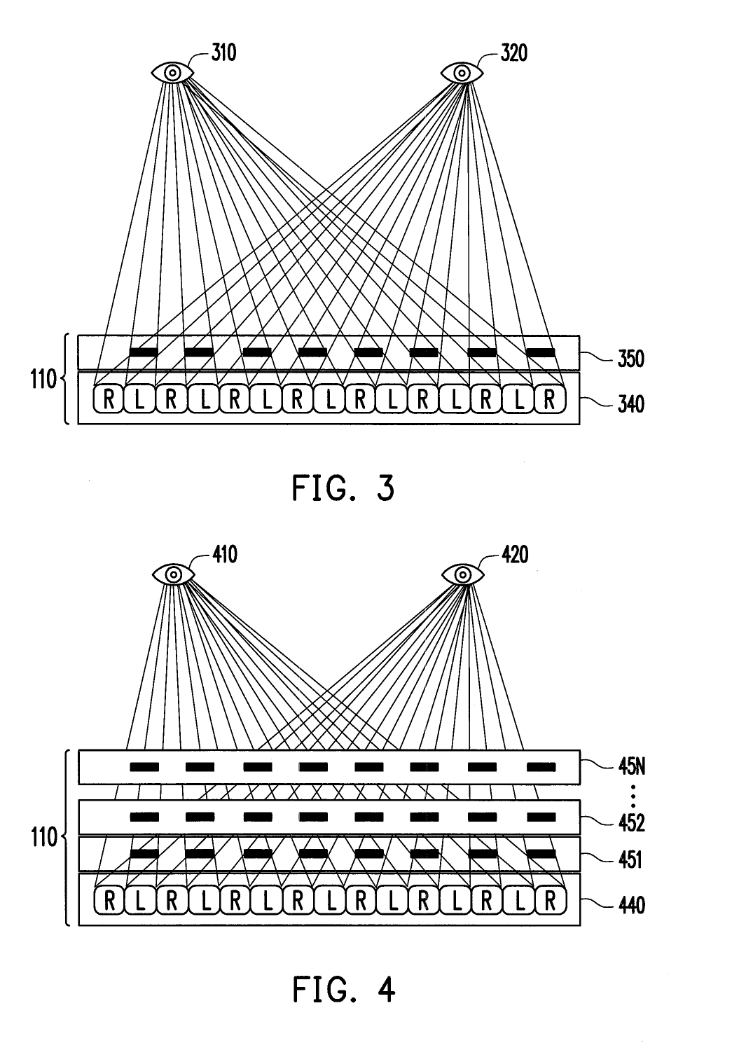

FIG. 3 is a schematic diagram showing the display unit 110 and the eyes 310 and 320 of the user according to an embodiment of the present invention. In this embodiment, the display unit 110 comprises a pixel layer 340 and a barrier layer 350. The pixel layer 340 includes a plurality of right pixels R belonging to a right image and a plurality of left pixels L belonging to a left image. The right image and the left image may be received from the right camera 140 and the left camera 150, or be accessed from a storage device. As shown in FIG. 3, the right pixels R and the left pixels L are disposed alternately in the pixel layer 340. The 3D image or the 2D image displayed on the display unit 110 may consist of two sub-images. The right pixels R may display the first sub-image of the 3D image or the 2D image, while the left pixels L may display the second sub-image of the 3D image or the 2D image.

The barrier layer 350 is disposed in front of the pixel layer 340 and is configured for masking the right pixels R and the left pixels L such that the right eye 310 of the user sees only the first sub-image and the left eye 320 of the user sees only the second sub-image when the eyes 310 and 320 of the user are at the right position for viewing the 3D image on the display unit 110.

For the 3D image apparatus 100, the two sub-images may be provided by the right camera 140 and the left camera 150. When the processor 130 displays the 3D image on the display unit 110, the right camera 140 provides the first sub-image and the left camera 150 provides the second sub-image. The two cameras 140 and 150 simulate the two eyes of the user, and capture the first sub-image and the second sub-image respectively. When the eyes 310 and 320 of the user are at the right position and the two sub-images are displayed by the right pixels R and the left pixels L in the interlaced manner as shown in FIG. 3, the right eye 310 of the user sees only the first sub-image and the left eye 320 of the user sees only the second sub-image. As a result, the brain of the user merges the two sub-images and feels like seeing a real 3D scene.

When the processor 130 instructs the display unit 110 to switch to 2D display mode, either the right camera 140 or the left camera 150 may provide both the first sub-image and the second sub-image. Since the sub-images displayed by the right pixels R and the left pixels L are from the same camera (140 or 150), the user sees a conventional 2D image on the display unit 110. In the embodiment of the invention, the barrier layer 350 needs not be turn off since both eyes would see the same image.

When the processor 130 displays the 2D image on the display unit 110, the contents of the two sub-images may be identical in one embodiment of the invention. In this situation, either the right camera 140 or the left camera 150 provides the same sub-image to the right pixels R and the left pixels L. This effectively reduces the resolution of the display unit 110 by half. Alternatively, the right camera 140 or the left camera 150 may provide different sub-images to the right pixels R and the left pixels L respectively. Since the display unit 110 may be a small display for previewing 3D images, the resolution of the display unit 110 may be much smaller than that of the right camera 140 and the left camera 150. In this situation, the right camera 140 or the left camera 150 is capable of outputting more pixel data to maintain the resolution of the display unit 110. In this embodiment, the barrier layer 350 is turn off and both eyes would see both images.

The barrier layer 350 works effectively only when the eyes 310 and 320 of the user are at the right position, which means both of the relative position between the eyes 310 and 320 of the user and the display unit 110 and the relative position between the eyes 310 and 320 of the user and the face of the user have to be within certain visible range. Regarding the 3D image apparatus 100, the user may feel dizzy when viewing the 3D image at a wrong position. In order to solve the dizziness problem, the processor 130 displays the 3D image on the display unit 110 when the eyes 310 and 320 of the user are at the right position for viewing the 3D image on the display unit 110. Otherwise, the processor 130 displays the 2D image on the display unit 110.

Regarding the 3D image apparatus 100, being at the right position is not enough because the focusing operation of the cameras 140 and 150 is also a potential cause of dizziness. In this situation, the processor 130 may display the 3D image on the display unit 110 upon the focusing of both the right camera 140 and the left camera 150 is finished and the eyes 310 and 320 of the user are at the right position. Otherwise, the processor 130 may temporarily display 2D images on the display unit 110 to protect the user from dizziness.

In some embodiments of the present invention, the processor 130 may instruct to turn on the barrier layer 350 for the aforementioned masking of the pixels or turn off the barrier layer 350 to disable the masking of the pixels. In those embodiments, the barrier layer 350 may be turn on when 2D images are displayed on the display unit 110. Alternatively, the barrier layer 350 may be turn on when displaying 3D images on the display unit 110 and be turn off when displaying 2D images on the display unit 110.

FIG. 4 is a schematic diagram showing the display unit 110 and the eyes 410 and 420 of the user according to another embodiment of the present invention. In this embodiment, the display unit 110 includes multiple barrier layers to provide a wider 3D viewing range for the user. In this embodiment, the display unit 110 includes a pixel layer 440 and N barrier layers 451-45N. N is a preset integer greater than one. The pixel layer 440 is similar to the pixel layer 440. Each of the barrier layers 451-45N is disposed at a different distance from the pixel layer 440 for masking the right pixels R and the left pixels L such that the right eye 410 of the user sees only the aforementioned first sub-image and the left eye 420 of the user sees only the aforementioned second sub-image when the eyes 410 and 420 of the user are at a corresponding position.

The processor 130 may use the image of the eyes 410 and 420 taken by the front camera 120 to determine the eyes 410 and 420 of the user are at the corresponding position of which barrier layer. When the eyes 410 and 420 of the user are at the corresponding position of one of the barrier layers 451-45N, the processor 130 displays the 3D image on the display unit 110 and turns on that one barrier layer and turns off the other barrier layers 451-45N. When the eyes 410 and 420 of the user are not at the corresponding position of any one of the barrier layers 451-45N, the processor 130 displays the 2D image on the display unit 110 to protect the user from dizziness. The processor 130 may turn off all of the barrier layers 451-45N when displaying the 2D image on the display unit 110.

In summary, the present invention determines to display the 3D image or the 2D image based on the position of the eyes of the user. In some embodiments of the present invention, the decision between the 3D image and the 2D image is made based on both the focusing state of the 3D camera and the position of the eyes of the user. Consequently, the present invention displays the 3D image only when the user can view the 3D image properly, thus protecting the user from feeling dizzy.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional (3D) image apparatus, comprising:
a display unit, configured to support a 3D display mode and a 2D display mode;
a front camera, for capturing an image of eyes of a user; and
a processor, coupled to the display unit and the front camera, and for determining an eye position of the user based on the image of the eyes of the user, and determining whether to provide at least one image to be displayed on the display unit in the 3D mode or the 2D mode based on the eye position of the user.

2. The 3D image apparatus of claim 1, wherein in response to the eye position of the user being in a predetermined range, the processor instructs the display unit to display the at least one image in the 3D display mode; and in response to the eye position of the user being not in the predetermined range, the processor instructs the display unit to display the at least one image in the 2D display mode.

3. The 3D image apparatus of claim 2, wherein the eye position comprises a first relative position between the eyes of the user and the display unit, and a second relative position between the eyes and a face of the user.

4. The 3D image apparatus of claim 1, wherein the display unit further comprises:
a pixel layer, comprising a plurality of right pixels and a plurality of left pixels, wherein the right pixels display a first sub-image of the at least one image, the left pixels display a second sub-image of the at least one image, the right pixels and the left pixels are disposed alternately in the pixel layer; and
at least one barrier layer, disposed in front of the pixel layer for masking the right pixels and the left pixels so as to provide the first sub-image to the right eye of the user and the second sub-image to the left eye of the user in response to the display unit is in the 3D display mode.

5. The 3D image apparatus of claim 4, wherein the at least one barrier layer is turn on in response to the display unit is in the 2D display mode, and the first sub-image is identical to the second sub-image.

6. The 3D image apparatus of claim 4, wherein the at least one barrier layer is turn on in response to the display unit is in the 3D display mode and is turn off in response to the display unit is in the 2D display mode.

7. The 3D image apparatus of claim 4, wherein the display unit comprises a plurality of barrier layers, each of the barrier layers is disposed at a different distance from the pixel layer for masking the right pixels and the left pixels in the 3D display mode.

8. The 3D image apparatus of claim 7, wherein the display unit selects to turn on at least one of the plurality of barrier layers and turn off the others of the plurality of barrier layers according to the eye position of user in the 3D display mode; and the display unit turns off the plurality of barrier layers in the 2D display mode.

9. The 3D image apparatus of claim 4, further comprising:
a right camera, coupled to the processor and for capturing a right image; and
a left camera, coupled to the processor and for capturing a left image;
wherein in response to the right camera and the left camera complete focus operation and the eye position of the user is within the predetermined range, the processor instructs the display unit to display in the 3D mode, otherwise the processor instructs the display unit to display in the 2D mode.

10. The 3D image apparatus of claim 9, wherein in response to the display unit is in the 3D display mode, the right camera provides the first sub-image and the left camera provides the second sub-image; in response to the display unit is in the 2D display mode, the first sub-image and the second sub-image are provided by either the right camera or the left camera.

11. A method for displaying images, comprising:
capturing an image of a user;
determining a viewing position of the user based on the image of the user; and
determining whether to display a three-dimensional (3D) image or a two-dimensional (2D) image on a display unit based on the viewing position of the user.

12. The method of claim 11, further comprising:
displaying the 3D image on the display unit in response to the viewing position of the user in a 3D visible range; and
displaying the 2D image on the display unit in response to the viewing position of the user is not in the 3D visible range.

13. The method of claim 12, wherein the viewing position comprises a first relative position between eyes of the user and the display unit, and a second relative position between the eyes and a face of the user.

14. The method of claim 11, further comprising
providing a plurality of right pixels and a plurality of left pixels disposed alternatively a pixel layer of the display unit;
displaying a first sub-image of the 3D image or the 2D image by the right pixels;
displaying a second sub-image of the 3D image or the 2D image by the left pixels;
providing at least one barrier layer disposed in front of the pixel layer for masking the right pixels and the left pixels so as to provide the first sub-image to the right eye of the user and the second sub-image to the left eye of the user in response to the display unit is in the 3D display mode.

15. The method of claim 14, further comprising:
turning on the at least one barrier layer in response to the display unit is in the 2D display mode.

16. The method of claim 14, further comprising:
turning on the at least one barrier layer in response to the display unit is in the 3D display mode; and
turning off the at least one barrier layer in response to the display unit is in the 2D display mode.

17. The method of claim 14, further comprising:
providing a plurality of barrier layers disposed at different distances from the pixel layer for masking the right pixels and the left pixels in the 3D display mode.

18. The method of claim 17, further comprising:
selectively turning on at least one of the plurality of barrier layers and turning off the others of the plurality of barrier layers according to the viewing position of the user in response to the display unit is in the 3D display mode; and
turning off the plurality of barrier layers in response to the display unit is in the 2D display mode.

19. The method of claim 14, further comprising:
upon completion of focus operation by a right camera and a left camera and the viewing position of the user being in a predetermined range, displaying the 3D image on the display unit; and
otherwise, displaying the 2D image on the display unit.

20. The method of claim 19, further comprising:
providing the first sub-image by the right camera and providing the second sub-image by the left camera in the 3D display mode; and
selectively providing the first sub-image and the second sub-image by the right camera or the left camera in the 2D display mode.
